(19) United States
(12) Patent Application Publication
(10) Pub. No.: US 2006/0244597 A1
(43) Pub. Date: Nov. 2, 2006

(54) Surgical instrument tray RFID tag

(75) Inventors: Steven M. Tethrake, Collierville, TN (US); Robert Varner, Germantown, TN (US); Jeffrey H. Nycz, Collierville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: SDGI Holdings, Inc.

(21) Appl. No.: 11/341,489

(22) Filed: Jan. 30, 2006

Related U.S. Application Data
(63) Continuation-in-part of application No. 11/116,360, filed on Apr. 28, 2005.

(51) Int. Cl. G08B 13/14

(52) U.S. Cl. 340/572.1; 340/539.1

(57) ABSTRACT

A surgical instrument tray RFID tag that includes a modular housing formed of two or more pieces of non-conductive, fluid impervious material. The two or more pieces are mated using an adhesive assisted seal to provide a sealed unitary structure that encases the RFID transponder circuit inside. Various fastening mechanisms may be used to fasten the tag to a surgical instrument tray such as adhesives, screws, bolts, rivets or other suitable mechanical fasteners. By hardening the outer case rather than the tag itself, various commercially available RFID transponder tags may be used with the various embodiments of the invention. The modular housing should be constructed of a protective material that will prevent ingress of moisture and dust, insulate from heat and cold but that will allow radio frequency waves to pass without significant attenuation. The tag may attached to surgical instruments during manufacture, or afterwards through a retrofitting process.

### CROSS REFERENCE TO RELATED APPLICATION(S)

This application is a continuation-in-part of U.S. patent application Ser. No. 11/116,360 filed Apr. 28, 2005 and entitled “Smart Instrument Tray RFID Reader,” which, is hereby incorporated by reference in its entirety.

### FIELD OF THE INVENTION

Embodiments of the invention generally relate to radio frequency identification systems, and more particularly to a surgical instrument tray RFID transponder tag for use with a variety of different surgical instrument trays and/or kits.

### DESCRIPTION OF RELATED ART

Surgical instrument storage and sterilization systems are known in the art. These systems, referred to as surgical instrument trays, surgical instrument kits, surgical trays and/or surgical kits typically consist of trays or boxes that hold a variety of general purpose and/or procedure specific surgical instruments such as forceps, scissors, clamps, retractors, scalpels, etc. These surgical instrument trays are brought into the operating room (OR) when preparing for surgery, and also are used as a means to organize and store surgical instruments in a medical facility and even to transport instrument in and out of medical facilities.

Due to advances in medical technology that have increased the number of surgical instruments now in use and due to the constant pressure in the health care industry to reduce operating costs, it has become necessary to manage and track these instruments trays more quickly and efficiently. One advancement towards this end has been the creation of surgical instrument trays that employ various techniques for controlling the arrangement of instruments on the tray so that any missing instruments can be identified quickly. Once such method is disclosed in U.S. Pat. No. 6,158,437, which uses a combination of instrument identifying indicia including a plurality of graphical indicia that represent an outline of the basic shape of each instrument, as well as a terse written description of the instrument to identify the correct placement of specific surgical instruments on the tray.

Another method of monitoring the contents of surgical instrument trays is disclosed in U.S. Pat. No. 6,426,041, which utilizes a plurality of recessed sections of applicable shape and size distributed on the work surface of the tray to accommodate specific instruments. Upon extraction from the tray, the instruments are in ready position to be relayed to the person performing the operation. U.S. Pat. Nos. 6,158,437 and 6,426,041 are hereby incorporated by reference in their entireties. Through implementation of the teachings of these patents, a person can visually inspect a surgical instrument tray and make a determination as to whether any instruments are missing or misplaced.

Another function provided by surgical trays is to facilitate group sterilization. Sterilization is of paramount importance in a surgical setting such as a hospital to prevent potentially deadly infections to patients undergoing surgery. Prior to every surgical procedure, all surgical instruments and trays must be sterilized. Also, following each surgical procedure, all instruments on a given tray, if not wrapped separately, whether soiled or not, must be re-sterilized before subsequent usage. In order to increase the speed and efficiency of sterilization, entire surgical trays containing several instruments often are placed in a sterilization chamber at once. The sterilization chamber may provide any combination of heat, pressure, and/or fluid or vaporous sterilant to the trays and all the instruments contained therein. Sterilization techniques are ubiquitously well known in the art. Thus, a detailed discussion of them has been intentionally omitted. As such, various surgical instrument trays and/or kits having holes formed therein have been proposed. These kits may be placed directly in a sterilization chamber. The holes allow for the ingress and egress of sterilant fluids and vapors.

Over time, and through ordinary usage, as well as due to the harshness of the sterilization process, surgical instruments suffer wear and tear and eventually reach the end of their life cycle. Thus, it has become necessary to periodically inspect and maintain records on usage of surgical instruments so that they can be replaced as necessary. Also, due to the fact that instruments are constantly moved from the operating room to sterilization, to storage, and back to the operating room, various instruments on a given tray may become lost, or unrelated instruments from other trays may be added. Because certain instruments are so specialized that there are no functional substitutes, it has become necessary to regularly inspect trays for any missing instruments and to readily identify specific instruments that are missing. Existing methods for performing these necessary functions are overly reliant on costly human interpretation. Also, in some cases, a skilled technician may be required to identify missing instruments. As with any human inspection process, the results are limited by the skill and accuracy of the person doing the inspecting.

Several methods currently exist for tracking and providing information about inventoried items that may be useful for tracking surgical instruments and trays. For example, in retail and manufacturing applications, inventory items typically carry printed labels providing information such as serial numbers, price, weight, manufacturing or use dates, and size. Usually, these labels are not machine readable, but rather require human interpretation. Another method for tracking and providing information about items that ameliorates some of the short comings of printed labels is bar code labeling. Bar code labels are characterized by a pattern of vertically oriented machine readable variable width bars that, when illuminated with a bar code scanner, create a reflection pattern that translates into a unique series of numbers. The series of numbers must then be correlated to product descriptions in a relational database in communication with the bar code scanner for purposes of identification, price checking, and inventory management.

Electronic data carrying memory devices are known. These devices provide a means for tracking and providing information about tools, equipment, inventory and other items. Memory devices permit linking of large amounts of data with an object or item. They typically include a memory and logic in the form of an integrated circuit (“IC”) and a mechanism for transmitting data to and/or from the product or item attached to the memory device. An example of such a memory device-based product identification technology is radio frequency identification (RFID).

Radio frequency identification (RFID) systems use an RF field generator (reader) to wirelessly extract identification information (i.e., UPC, product name, etc.) contained in RFID transponder attached to various products and objects. RFID tags are miniature electronic circuits that typically consist of a coil that acts as an antenna and a small silicon-based microprocessor with a memory, all encapsulated in a protective material. RFID tags store identification information, usually in the form of an identification number that corresponds to an object or item to which the tag is attached. This number may be used to index a database containing price, product name, manufacture and/or other information. When a transponder tag enters an RF field generated by a reader device, the circuit of the tag becomes energized causing the processor to perform a data operation, usually by emitting a signal containing the processor's stored information. The basic structure and operation of RFID tags can be found in, for example, U.S. Pat. Nos. 4,075,632, 4,360,801, 4,390,880, 4,739,328 and 5,030,807, the disclosures of which are hereby incorporated by reference in their entirety.

RFID tags generally are formed on a substrate, such as, for example, paper, and can include analog RF circuits, digital logic, and memory circuits. RFID tags also can include a number of discrete components, such as capacitors, transistors, and diodes. RFID tags are categorized as either active or passive. Active tags have their own discrete power source such as a battery. When an active tag enters an RF field it is turned on and then emits a signal containing its stored information. Passive tags do not contain a power source. Rather, they become inductively or capacitively charged when they enter an RF field. Once the RF field has activated the passive circuit, the tag emits a signal containing its stored information. Passive RFID tags usually include an analog circuit that detects and decodes the interrogating RF signal and that provides power from the RF field to a digital circuit in the tag. The digital circuit generally executes all of the data functions of the RFID tag, such as retrieving stored data from memory and causing the analog circuit to modulate to the RF signal to transmit the retrieved data. In addition to retrieving and transmitting data previously stored in the memory, both passive and active dynamic RFID tags can permit new or additional information to be written to a portion of the RFID tag's memory, or can permit the RFID tag to manipulate data or perform some additional functions.

Though originally invented to track feeding of cattle, RFID tags are today utilized in a variety of applications including retail security, inventory management, and even computerized checkout. With the price of RFID tags now reaching as low as 5 cents per tag, and because of reductions in size due to an overall trend towards miniaturization in circuit design, RFID tags currently are being applied to many types of products, both at the consumer level as well as in manufacturing processes. RFID tags enable manufacturers to wirelessly track products from the manufacturing stage to the point-of-sale. They provide a robust, cost effective, efficient and accurate solution to inventory tracking and management.

Current commercially available RFID tags, both active and passive, generally come in one of two configurations: inductively or capacitively coupled. Inductively coupled tags, the first type of RFID tags developed, consist of a silicon-based microprocessor, a metal coil wound into a circular pattern which serves as the tag's antenna, and an encapsulating material that wraps around the chip and coil. These tags are powered by an electromagnetic field generated by the tag reader. The tag's antenna picks up the electromagnetic energy which in turn powers the chip. The tag then modulates the electromagnetic field in order to transmit data back to the reader. Despite advances in silicon manufacturing processes, inductively coupled tags have remained relatively expensive due to the coil antenna and the manufacturing process required to wind the coil around the surface of the tag.

The second type of RFID tags, capacitively coupled tags, eliminate the metal coil, consisting instead of a silicon microprocessor, paper substrate, and a conductive carbon ink that is applied to the paper substrate through a conventional printing means. By using conductive ink and conventional printing processes, a relatively low cost, disposable tag can be created that is easily integrated into conventional product labels.

RFID tags are rapidly becoming the preferred method of inventory tracking in retail and distribution applications and will likely surpass bar codes as the preferred point-of-sale checkout identifier. Large retail chains such as WALMART Corporation are already requiring their suppliers to utilize RFID tags for tracking shipments. RFID tags have significant advantages over bar code labels. For example, bar codes are limited in size by resolution limitations of bar code scanners, and the amount of information that the symbols can contain is limited by the physical space constraints of the label. Therefore, some objects may be unable to accommodate bar code labels because of their size and physical configuration. In contrast, RFID tags store their information in digital memory. Thus, they can be made much smaller than bar code tags.

Another advantage of RFID tags over bar codes is that bar code readers requires line of sight in order to read the reflection pattern from a bar code. As labels become worn or damaged, they can no longer be read with the bar code scanner. Also, because a person operating the bar code scanner must physically orient either the scanner or the product to achieve line of sight on each item being scanned, items must be scanned one at a time resulting in prolonged scan time. RFID tags, on the other hand, are read through radio waves, which do no require line of sight because they are able to penetrate light impermeable materials. This not only eliminates the line of sight requirement, but also allows rapid identification of a batch of tagged products.

Yet another relative advantage of RFID tags over bar code labels is that for dynamic RFID tags, the information stored in the tag may be updated using a writing device to wirelessly transmit the new information to be stored. Updating information in bar code tags typically requires printing a new tag to replace the old.

One problem associated with the use of RFID tags, which also is common to bar code tags, is that it can be difficult to securely attach the tags to various goods and products. As discussed above, capacitively coupled RFID tags usually are printed on a paper substrate and then attached to various items using an adhesive bonding. However, in some applications, a paper tag may not hold up to the rigors of the environment in which the product is used. For example, in the field of medical equipment, and in particular, surgical instruments and surgical instrument storage and sterilization systems, items are routinely exposed to environments containing various combinations of high temperatures, high pressure and liquid, vaporous and/or gaseous chemical sterilants. Even in non-medical environments, hand tools and other equipment may be subjected to harsh physical conditions through ordinary use. Over time, a paper RFID tag would not provide reliable performance under these harsh conditions. More rugged RFID tags have been developed as a potential solution to this problem. An example of a rugged RFID tag is provided in U.S. Pat. No. 6,255,949, the disclosure of which is hereby incorporated by reference in its entirety. The '949 patent discloses an RF transponder tag surrounded by a thermally resistant polymer and encapsulated in a hardened case. Because radio frequency waves can penetrate such materials, performance of the tag is not degraded by the case or polymer. Such a configuration prevents damage to the transponder tag if exposed to high temperature environments.

Therefore, there is a need for an RFID tag that can be used to identify surgical instrument trays that can withstand the rigors of sterilization, can be easily retrofitted to existing trays and can be manufactured with minimal modification to existing tag designs.

The description herein of various advantages and disadvantages associated with known apparatus, methods, and materials is not intended to limit the scope of the invention to their exclusion. Indeed, various embodiments of the invention may include one or more of the known apparatus, methods, and materials without suffering from their disadvantages.

### SUMMARY OF THE INVENTION

Based on the foregoing, it would be desirable to provide an RFID tag that overcomes or ameliorates some or all of the shortcomings of conventional tags. In particular, it would be desirable to provide an RFID tag that can withstand the rigors of sterilization and other harsh environments and that can also be cheaply and easily used with new as well as existing instruments and equipment, and that can remain securely attached to objects without losing readability.

Thus, it is a feature of various embodiments of the invention to provide an RFID tag that is sufficiently ruggedized to permit use of the tag in moist, heated, cooled, pressurized or other destructive environments.

Another feature of various embodiments of the invention provides an RFID tag that can be attached securely attached to objects such as surgical instrument trays.

Yet an additional feature of various embodiments of the invention provides an RFID tag that is operable to protect internal tag circuitry from physical damage.

Still a further feature of various embodiments of the invention provides an RFID tag that is compatible with existing commercially available tag circuits.

To achieve the above-noted features, and in accordance with the purposes as embodied and broadly described herein, one exemplary embodiment provides a surgical instrument tray RFID tag. The surgical instrument ray RFID tag according to this embodiments comprises a first tag portion adapted on at least one surface to be mated to a surgical instrument tray, a second tag portion adapted to mate with the first portion to form a unitary structure, and an RFID transponder circuit located between the first and second portion.

In accordance with another exemplary embodiment, an RFID tag is provided. The RFID tag according to this embodiment comprises a first enclosure portion having a cavity formed therein that is adapted to receive an RFID transponder tag, and a second enclosure portion adapted to mechanically mate with the first enclosure portion with an adhesive seal to form an airtight, unitary structure encasing the RFID transponder tag.

In accordance with a further exemplary embodiment of the invention, a method of manufacturing an RFID tag is provided. The method according to this embodiment comprises forming first enclosure portion, forming a second enclosure portion, inserting an RFID transponder circuit in the second portion, and mating the second portion to the first portion to form a sealed, unitary structure.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

Purposes and advantages of the embodiments will be apparent to those of ordinary skill in the art from the following detailed description in conjunction with the appended drawings in which like reference characters are used to indicate like elements, and in which:

FIG. 1 is a perspective view of a surgical instrument tray including a surgical instrument RFID tag according to at least one embodiment of the invention;

FIG. 2 is a close up partial perspective view of a surgical instrument tray RFID tag according to at least one embodiment of the invention;

FIG. 3 is an internal perspective view of a surgical instrument RFID tag according to at least one embodiment of the invention;

FIG. 4 is an exploded profile view of a surgical instrument RFID tag according to according to at least one embodiment of the invention; and

FIG. 5 is an exploded profile view of another surgical instrument RFID tag according to at least one embodiment of the invention.

### DETAILED DESCRIPTION

The following description is intended to convey a thorough understanding of the embodiments described by providing a number of specific embodiments and details involving surgical instrument tray RFID tags and methods of manufacturing surgical instrument tray RFID tags. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

As used herein, the expressions “RFID tag” and “RFID transponder tag” will refer to any active or passive type of electronic data storage device, read-only or read and write, that is wirelessly activated in the presence of a radio frequency (RF) field, including any currently available inductively coupled RFID tags, capacitively coupled RFID tags and even future RF-type tags not yet available. This includes tags operating in the 125 kHz, 13.56 MHz, 868-927 MHz, 2.45 GHz and 5.8 GHz frequency bands as well as other suitable frequency bands. Also, the tag may be a silicon-type IC tag, a printed tag printed with a conductive ink-based printing process or a tag formed by other suitable means.

As used herein, the expressions and terms “surgical instrument,” “medical instrument,” “instrument,” or “device” will refer to any type of surgical or medical instrument, portable equipment or device, tool or hand tool, to which it may be desirable to attach an RFID tag. Though the specification is written in the context of medical and/or surgical instruments, it should be appreciated that the surgical instrument RFID tag of the embodiments may be used with a variety of different items to be identified as shape and design constraints permit, including tools and equipment in other fields unrelated to the medical field. This may include hand tools or other objects and/or equipment that are used in construction, manufacturing, maintenance or other industries. All of these uses are within the intended scope of the embodiments of the invention.

Through out this description, the expression “surgical instrument RFID tag” will be given broad meaning including, but not limited to, any type of RFID transponder tag that consists of a transponder circuit that is encased in a modular, rigid protective housing that protects the tag circuit from damage while permitting propagation of electromagnetic waves. In this manner a variety of commercially available RFID transponder tags/circuits may be utilized, even those that without the protective housing would be destroyed by typical sterilization/autoclave environments. Also, the “surgical instrument tray RFID tag” according to the various embodiments will include an attachment mechanism for attaching the tag to a surgical instrument tray. This may include a flat surface that can be mated to a tray surface with an adhesive. This may also include one or more through holes adapted to receive a rivet, bolt, screw or other mechanical fastener that can be attached to a surgical instrument tray such as by drilling or punching a hole.

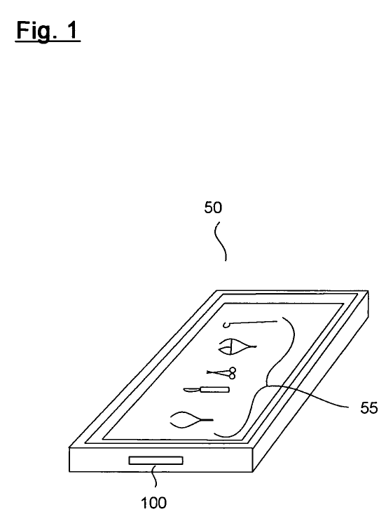

Referring now to FIG. 1, a surgical instrument tray 50 including a plurality of surgical instruments 55 is illustrated in accordance with at least one exemplary embodiment of the invention. As shown in FIG. 1, the surgical instrument tray 50 comprises a box-like structure having a hollowed body and a roughly planar top surface surrounded on its perimeter by a raised lip that prevents instruments from sliding off of the tray. Typically, surgical instrument tray bodies are made of a plastic or other non-corrosive, relatively lightweight material such as titanium or stainless steel. In FIG. 1, for purposes of example only, the surgical instrument tray 50 is shown as being flat. However, it should be noted that surgical instrument tray may also contain one or more recesses shaped to receive various surgical instruments without departing from the spirit or scope of this invention. Alternatively, the surgical instrument tray may be of a kit configuration in which surgical instrument are placed inside the tray body in a drawer or box such that they can be enclosed by the tray body when direct access to the individual instruments is not required. Furthermore, though the tag 100 is depicted as being mounted in a surface mount configuration on the tray 50, it should be appreciated that the tag 100 may be mounted in a recess to effect a flush mount, or, the tag may be mounted on a bottom surface, inside surface or other configuration without departing from the spirit or scope of the invention. Neither the specific location on the surgical instrument tray that the tag is mounted nor the mechanism by which it is mounted is critical to the various embodiments invention.

As discussed herein, RFID tagging of surgical instrument trays may permit efficient tracking and distribution of surgical instrument and surgical instrument trays in medical facilities, in distribution warehouses, sterilization facilities and in other environments. Various embodiments of the invention may be used with RFID-based inventory systems such as those disclosed in commonly assigned U.S. patent application Ser. Nos. 10/924,897 entitled “Automated Pass-Through Surgical Instrument Tray Reader,” filed Aug. 25, 2004, Ser. No. 11/006,750 entitled “Workstation RFID Reader for Surgical Instruments and Surgical Instrument Trays and Methods of Using Same,” filed Dec. 8, 2004, and Ser. No. 11/116,360 entitled “Smart Instrument Tray RFID Reader,” filed Apr. 28, 2005, all of which are hereby incorporated by reference in their entirety. The surgical instrument tray RFID transponder tag according to the various embodiments described herein may be used with any of the above instrument tray reading systems or with any other RFID-based instrument tray tracking system.

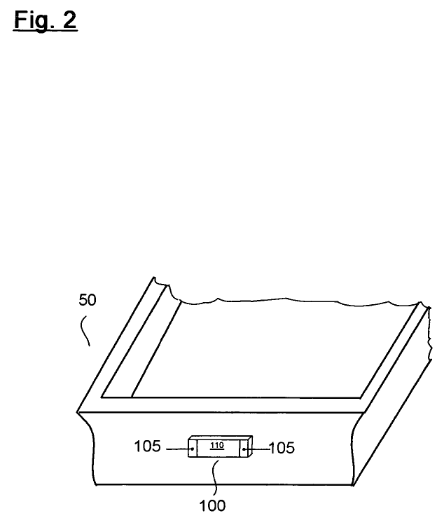

Referring now to FIG. 2, a close up view of the surgical instrument tray RFID tag 100 of FIG. 1 is depicted in accordance with at least one embodiment of the invention. The tag 100 comprises a tag housing structure 110 that is attached to a surgical instrument tray 50 using mechanical fasteners 105. In the example shown in FIG. 2 there are two mechanical fasteners 105 that pass through a pair of through holes in the tag housing structure 110. In various embodiments, the mechanical fasteners may comprise rivets, screws, bolts, or other suitable fasteners. Also, attachment may be aided by an adhesive that is applied between the tray 50 and tag housing 110, such as, for example, a two part medical grade silicone adhesive. In various embodiments, the adhesive may also be used to seal the tag portions together and/or to fill the through holes once the tag is attached to a surgical instrument tray. As discussed herein, the particular place of attachment on the surgical instrument tray as well as the means utilized to attach the tag to the tray are not critical to the various embodiments of the invention.

In various embodiments, and as will be discussed in greater detail herein, the tag housing structure 110 may be formed of one or more materials selected from the group consisting of plastic, resin, glass, rubber, graphite, Lucite, etc., that protect internal tag circuitry from exposure to outside environments, but that will also allow radio frequency signals to propagate through with only minor attenuation. In various embodiments, the tag housing 115, 120 may be made of a material such as amorphous thermoplastic polyetherimid or polyphenylene sulfide. In various embodiments, the tag housing structure 110 will protect the transponder circuit contained therein against one or more of the following environmental hazards: heat, cold, moisture, overpressure, shock, torsion and compression. During ordinary course of use, surgical instruments are routinely exposed to these hazards through actual use, sterilization and transport.

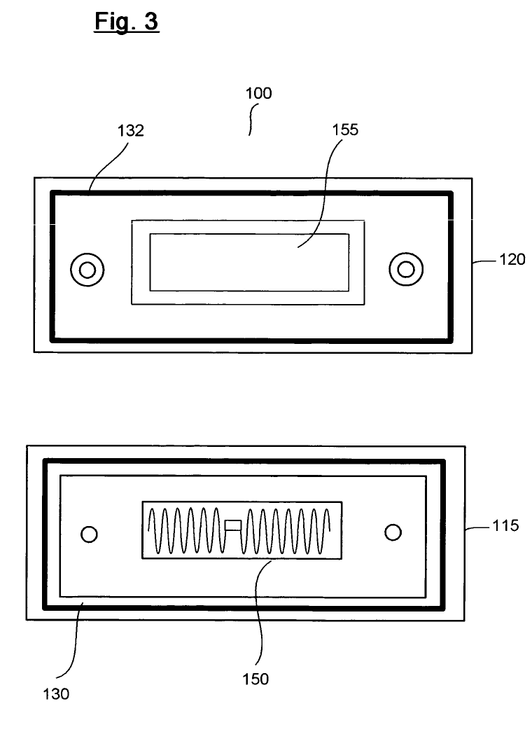

Referring now to FIG. 3, an internal perspective view of a surgical instrument RFID tag according to at least one embodiment of the invention is illustrated. The tag 100 comprises a first housing portion 115 that mates with a second housing portion 120 to form a unitary housing structure. In the embodiment of FIG. 3, the transponder tag circuit 150 is located in the first housing portion 115. A channel formed in the first housing portion is adapted to receive a ridge 132 formed in the second housing portion 120. In various embodiments, the ridge 132 may be a ridge formed directly into the second housing portion 120, a gasket, a glue seal, or combinations of the above. Once the RFID transponder circuit 150 is placed in the first portion 115, compression will cause the ridge 132 and recess 130 to form an airtight, waterproof seal that will protect the tag circuit 150 from damage caused by environments outside the tag 100. In the embodiment depicted in FIG. 3, the first and second tag portions 115, 120, also comprise though holes through which rivets, bolts, screws or other mechanical fasteners can pass, thereby allowing the tag 100 to be mechanically attached to surgical instrument trays or other items to be identified. In various embodiments, the through holes in the first and second portions 115, 120 will also have respective recess and ridge portions surrounding the holes so that the holes do not compromise the integrity of the seal when the two portions are mated.

The transponder tag circuit 150 may be any commercially available RFID transponder tag. Because the first and second housing portions 115, 120 provide protection from outside environments, the tag circuit itself 150 need not be hardened or otherwise protected. This will allow compatibility with a variety of different RFID tag circuits. In various embodiments the RFID transponder circuit 150 will rest in a recess in either the first portion 115, second portion 120 or both. In various embodiments, the first and second portions will be dimensioned such that the RFID transponder circuit 150 is maintained at a predetermined minimum distance from a surgical instrument tray when the tag 100 is mounted on the tray. This will insure that metal content in the tray does not interfere with readability of the tag 100. The tag circuit 150 may or may not comprise an integral power supply. As is known in the art, in various embodiments, the transponder circuit 150 comprises a processor, which, may be configured in a miniature small outline package (MSOP) for integrated circuits. In various embodiments, the processor will contain a memory having locked and unlocked portions so that data can not only be read from the tag, but also, new data may be written to the tag. The transponder circuit may also comprises two antenna portions. Though in the various depicted embodiments, the antenna is shown as a wire antenna, it should be appreciated that the antenna may take different forms as well. For example, the antenna may comprise part of the substrate core. The antenna may also be a sheet of conductive foil or other configuration. The specific configuration of the transponder circuit 150 is not critical to the invention so long as it is contained within a protective housing.

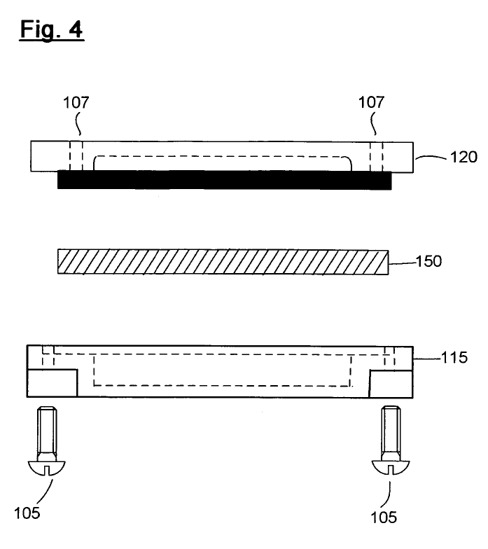

Referring now to FIG. 4, an exploded profile view of a surgical instrument RFID tag according to according to at least one embodiment of the invention is depicted. FIG. 4 illustrates how the components of the tag 100 of FIG. 3 may fit together to form a unitary tag structure. In various embodiments, an RFID transponder circuit 150 is sandwiched between first and second tag housing portions 115, 120 with the assistance of a ridge and recess sealing mechanism as discussed above in the context of FIG. 3. Recesses in either the first or second housing portions, or alternatively in both, hold the transponder circuit 150 in place. Also, a piece of deformable material (not shown) may reside in either the first or second housing portions 115, 120 to press against the transponder circuit 150 to hold it in place and prevent it from moving around in the tag housing 100 after the first and second portions are mated. In various embodiments, the deformable material may be made of foam, rubber, silicone or other deformable material.

It should be appreciated, that although the tag housing 120 is depicted in FIG. 4 as having substantially squared edges, one or more of the outer edge portions of the housing 120 may be chamfered or otherwise tapered to enhance the tag's ability to withstand impact. Furthermore, through holes 107 may be located in portions of the housing 120 that are separate from the opening containing the tag circuit 150, thereby preventing leakage from through hole areas into to the area containing the tag circuit 150.

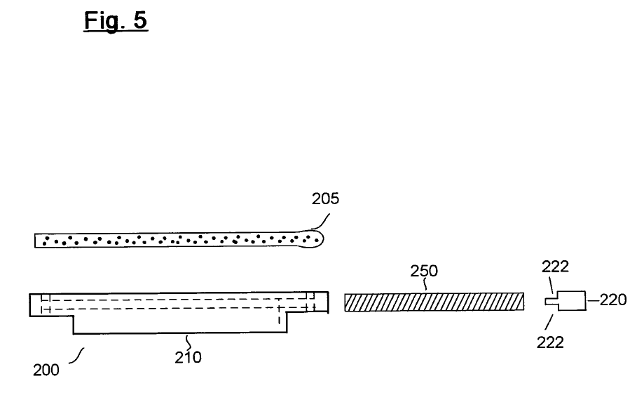

FIG. 5 is an exploded profile view of another surgical instrument RFID tag according to at least one embodiment of the invention. The tag 200 of FIG. 5 comprises a first housing portion 210 that has a cavity formed therein to receive a transponder circuit 250 via an opening formed in one end of the first housing portion 210. After the transponder circuit 250 is inserted into the first housing portion 210, the second housing portion 220 is inserted into the opening. Epoxy of other adhesive is applied to the flange area 222 of the second housing portion to maintain a permanent seal when the two portions 210, 220 are joined. In various embodiments, the first housing portion 210 may be dimensioned such that the transponder circuit 250 is firmly held in place once inserted into the first housing portion 210. An adhesive seal 205 applied to a surface of the unitary structure 200 formed by mating the first and second housing portions 210, 220 is used to mount the tag 200 onto a surgical instrument tray or other object. In various embodiments, this will replace the need for through holes, thereby simplifying the manufacturing process. In various embodiments, this may also supplant through holes.

Thus, the surgical instrument RFID tag according to the various embodiments discussed herein provides an efficient and effective solution for utilizing RF identification techniques to surgical instrument trays and other objects that must withstand heat, cold, chemical exposure, physical stress and other environmental hazards. By constructing the tag with a conventional transponder tag encased in a protective housing comprises of two or more portions of rigid dielectric material, the tag may be used in environments not otherwise possible. Also, through an injection molding process the first and second housing portions may be formed into a variety of different shapes, sizes and configurations as the application requires. Many commercially available or not yet available, non-hardened RFID transponder tag circuits may be utilized with the various embodiments of the invention enhancing the flexibility of implementation and without modification to the transponder tag manufacturing process thereby enhancing market acceptance.

The embodiments of the present inventions are not to be limited in scope by the specific embodiments described herein. For example, although many of the embodiments disclosed herein have been described with reference to a surgical instrument tray RFID tag used to identify surgical instrument trays, the principles herein are equally applicable to other aspects radio frequency-based identification where ruggedized tags are required. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

What is claimed:

1. A surgical instrument tray RFID tag comprising:
a first tag portion adapted on at least one surface to be mated to a surgical instrument tray;
a second tag portion adapted to mate with the first portion to form a unitary structure; and
an RFID transponder circuit located between the first and second portion.

2. The RFID tag according to claim 1, wherein the unitary structure is a casing that encapsulates the transponder circuit.

3. The RFID tag according to claim 1, wherein the first and second tag portions are constructed at least in part of a material selected from the group consisting of plastic, rubber, graphite, resin, and other electrically insulating, fluid impervious material.

4. The RFID tag according to claim 1, wherein the unitary structure formed by mating the first and second tag portions provides a fluid impervious barrier to the transponder circuit.

5. The RFID tag according to claim 1, wherein the unitary structure provides a pressure resistant barrier to the transponder circuit.

6. The RFID tag according to claim 1, wherein the first and second tag portions are constructed of a material that permits propagation of electromagnetic energy without significant attenuation.

7. The RFID tag according to claim 1, wherein the first tag portion is adapted to maintain the transponder circuit at a predetermined offset from the surgical instrument tray.

8. The RFID tag according to claim 1, further comprising a deformable material contacting at least one surface of the transponder circuit inside the unitary structure.

9. The RFID tag according to claim 1, further comprising a sealing material holding the first tag portion and second tag portion together.

10. The RFID tag according to claim 1, further comprising an attachment mechanism for attaching the RFID tag to a surgical instrument tray.

11. The RFID tag according to claim 10, wherein the attachment mechanism is an adhesive seal.

12. The RFID tag according to claim 10, wherein the attachment mechanism is a pair of through holes penetrating the unitary structure in at least two places and adapted to accommodate a rivet, bolt, screw or other mechanical fastener.

13. The RFID tag according to claim 1, wherein the RFID transponder circuit comprises a unitary insert that is placed in a recess in either the first or second tag portions prior to mating.

14. The RFID tag according to claim 1, further comprising one or more visual indicia on at least one non-instrument tray facing surface of the unitary structure.

15. The RFID tag according to claim 14, wherein the one or more indicia is an indicia selected from the group consisting of a brand owner name, a product name, a category name, a color code, a graphic image, a product identification number, a bar code and combinations thereof.

16. An RFID tag comprising:
a first enclosure portion having a cavity formed therein that is adapted to receive an RFID transponder tag; and
a second enclosure portion adapted to mechanically mate with the first enclosure portion with an adhesive seal to form an airtight, unitary structure encasing the RFID transponder tag.

17. The tag according to claim 16, wherein the first and second portions are constructed of a material selected from the group consisting of plastic, rubber, graphite, resin, and other electrically insulating, fluid impervious material.

18. The tag according to claim 16, wherein the unitary structure is adapted to be attached to a surgical instrument tray by a mechanical attachment means selected from the group consisting of an adhesive seal, a pair of rivets, a pair of bolts, a pair of screws, and combinations thereof.

19. The tag according to claim 16, wherein the unitary structure is adapted to maintain the RFID transponder tag at a minimum predetermined offset from a surface of a the surgical instrument tray.

20. A method of manufacturing an RFID tag comprising:
forming first enclosure portion;
forming a second enclosure portion;
inserting an RFID transponder circuit in the second portion; and
mating the second portion to the first portion to form a sealed, unitary structure.

21. The method according to claim 20, wherein forming the first and second enclosure portions comprises forming a recess in at least one of the first and second portions adapted to receive the transponder circuit.

22. The method according to claim 20, further comprising forming an attachment mechanism on at least one of the first and second portions.

23. The method according to claim 22, wherein forming an attachment mechanism comprises forming at least one flat surface adapted to be adhered to an item to be identified.

24. The method according to claim 22, wherein forming an attachment mechanism comprises forming a pair of through holes in at least one of the first and second enclosure portions adapted to permit passage of a rivet, bolt, screw, or other suitable mechanical fastener.

25. The method according to claim 20, wherein mating the second portion to the first portion comprises applying an adhesive seal to a contact area between the first and second portions.

26. The method according to claim 20, further comprising forming one or more visual indicia on at least one surface of the unitary structure.

27. The method according to claim 26, wherein the one or more indicia is an indicia selected from the group consisting of a brand owner name, a product name, a category name, a color code, a graphic image, a product identification number, a bar code and combinations thereof flexible sleeve designed to be pulled over a portion of an object to be identified.
